(19) United States
(12) Patent Application Publication
(10) Pub. No.: US 2012/0228504 A1
(43) Pub. Date: Sep. 13, 2012

(54) MEMS SENSOR AND SENSOR ARRAY HAVING THE SAME

(75) Inventors: Takanori Maeda, Kanagawa (JP); Takahiro Kawano, Kariya (JP); Kenjiro Fujimoto, Kotu (JP); Atsushi Onoe, Omiya (JP)

(73) Assignee: PIONEER CORPORATION, Kanagawa (JP)

(21) Appl. No.: 13/498,795

(22) PCT Filed: Sep. 29, 2009
(86) PCT No.: PCT/JP2009/004978

§ 371 Date: May 24, 2012

(51) Int. Cl. G01J 5/02

(52) U.S. Cl. 250/338.3

(57) ABSTRACT

A MEMS sensor has a membrane 3 in a polygon released via a support portion 2, and the membrane 3 has a reinforcement rib portion 6 made up of a plurality of radially extending rib portions 6a and a plurality of divisional membranes 7 constructed between adjacent two rib portions 6a, 6a and formed in a polygon with the two rib portions 6a, 6a as two sides.

### TECHNICAL FIELD

The present invention relates to a MEMS (micro electro mechanical system) sensor in a membrane structure which responds to temperature change, pressure change, vibration and the like, and a sensor array having the same.

### BACKGROUND ART

Generally, there has been known a thermal sensor in a membrane structure as this kind of MEMS sensor (see Patent Document 1). The thermal sensor has a square-shaped membrane formed by a thermal sensitive element and an upper and a lower electrodes, and a pair of support arms which support to release the membrane on a substrate. Each support arm serves as a wiring connected to an electrode and is formed by a thermal insulation material. The thermal sensitive element absorbs infrared rays and converts temperature change thereof to electrical signals, thereby the infrared rays can be detected.
[Patent Document 1] U.S. Pat. No. 6,087,661

### DISCLOSURE OF THE INVENTION

### Problems that the Invention is to Solve

In such a known thermal sensor, detection sensitivity can be enhanced by forming the membrane thinly and reducing thermal capacity. There arises a problem by forming the membrane thinly, in which warpage and crack is generated by stress (thermal stress, etc.) in a fabrication process, leading to an extremely low yield ratio. Further, by forming the membrane thinly, a resonance frequency is lowered. As to a sensor or the like for a vehicle, problems occur such that the membrane thereof is crashed by the resonance and a connection portion between the support arms and the membrane is broken. Still further, in a case that the thermal sensitive element of the membrane is made from ferroelectric, microphonics is generated by vibration and detection sensitivity drops off.

It is an advantage of the invention to provide a MEMS sensor which can be formed thinly while strength thereof can be maintained and a sensor array having the same.

### Means for Solving the Problems

According to an aspect of the invention, there is provided a MEMS sensor having a membrane with sensitivity as sensor in a polygon supported by a support portion, the membrane having a reinforcement rib portion made up of a plurality of radially extending rib portions and a plurality of divisional membranes that are constructed between adjacent two rib portions and formed in a polygonal shape with the two rib portions as two sides, and the MEMS sensor constituting each element of a sensor array.

According to the structure, since the membrane has the plurality of radially extending rib portions and the plurality of divisional membranes that are constructed between adjacent two rib portions and formed in a polygonal shape with the two rib portions as two sides, rigidity (strength) of the membrane as a whole can be increased while an area of a sensitive portion is sufficiently maintained. Therefore, it is possible to form the membrane thinly while a yield ratio is maintained highly, without lowering detection sensitivity. Further, a resonance frequency can be extremely raised because of the plurality of rib portions, thereby crack/breakage by vibration can be avoided and microphonics can not be generated.

In this case, it is preferable that the adjacent two divisional membranes be connected to the two rib portions in different flat surfaces respectively.

More specifically, it is preferable that one of the adjacent two divisional membranes be connected to a front end portion of the two rib portions in a width direction and the other be connected to a back end portion of the two rib portions in the width direction.

According to the structure, the membrane as a whole can have a convexoconcave shape in units of divisional membrane, and rigidity (strength) of the membrane can be further increased.

Further, it is preferable that length between the adjacent two divisional membranes in a front and back direction be longer than thickness of the membrane.

According to the structure, strength of each rib portion can be increased and rigidity (strength) of the membrane as a whole can be increased.

Further, it is preferable that the polygon to be a shape of the divisional membrane be either a triangle or a quadrangle.

According to the structure, the sensor array can be formed in which the rib portions are shared in the adjacent MEMS sensors, and the sensor array has high rigidity while an area ratio of the membrane (sensitive portion) is maintained.

It is preferable that the membrane be formed by laminating an upper electrode layer, a pyroelectric layer and a lower electrode layer.

According to the structure, it is possible to provide an infrared ray sensor having a high yield ratio and high detection sensitivity.

According to another aspect of the invention, there is provided a sensor array having a plurality of MEMS sensors disposed in a planar surface as described above, and a connection rib portion connected to the two rib portions is formed at a connection portion of the adjacent two MEMS sensors.

According to the structure, an area ratio of the membrane (sensitive portion) can be increased and the sensor array having high rigidity and high detection sensitivity can be provided.

As described above, according to the invention, since the membrane is formed by the plurality of radial rib portions and the plurality of divisional membranes formed in a polygon, rigidity (strength) of the membrane as a whole can be increased. Further, crash/breakage by vibration can be avoided by the plurality of rib portions. Therefore, a yield ratio and detection sensitivity can be improved.

### BRIEF DESCRIPTION OF THE DRAWINGS

FIG. 1 is a perspective view of an infrared ray sensor according to a first embodiment of the invention.

FIG. 2 is a cross sectional view of the infrared ray sensor according to the first embodiment.

FIGS. 3A and 3B are cross sectional views of the infrared ray sensor according to a modification.

FIGS. 4A-4F are explanatory views of a fabrication method of the infrared ray sensor according to the first embodiment.

FIG. 5 is a partial perspective view of a sensor array (infrared ray detection apparatus) applied with the infrared ray sensor of the first embodiment.

FIG. 6 is a partial plan view of the sensor array according to a modification.

FIG. 7 is a perspective view of the infrared ray sensor according to a second embodiment.

FIG. 8 is a cross sectional view of a sensor array (infrared ray detection apparatus) applied with the infrared ray sensor of the second embodiment.

### DESCRIPTION OF EXEMPLARY EMBODIMENTS

An infrared ray sensor as a MEMS sensor according to one embodiment of the invention and a sensor array using the infrared ray sensor will be explained with reference to accompanying drawings. The infrared ray sensor is fabricated by microfabrication technology with a silicon (wafer) material and the like, and is formed, as it is called, as a pyroelectric type infrared ray (far-infrared ray) sensor. Further, the infrared ray sensor forms a pixel (element) of the sensor array (infrared ray detection apparatus) fabricated in an array form.

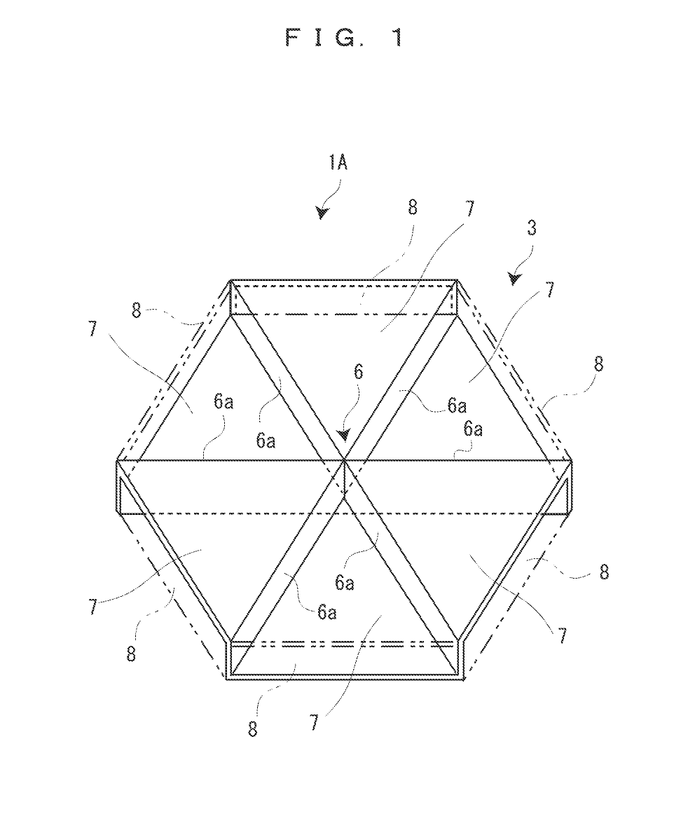

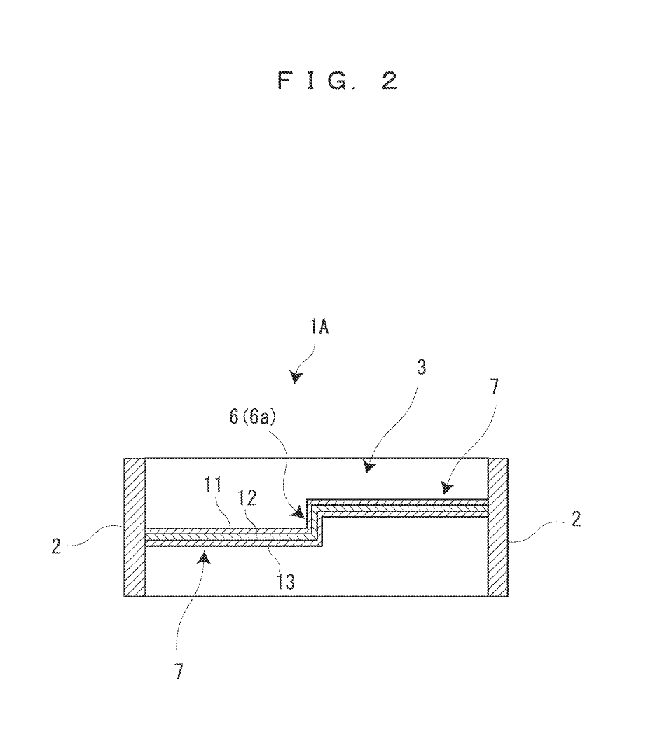

As illustrated in FIGS. 1 and 2, an infrared ray sensor 1A has a pair of column portions 2, 2 which constitutes a support portion, and membrane 3 in a hexagonal shape supported by the pair of column portions 2, 2. The membrane 3 has a reinforcement rib portion 6 which is made up of a plurality (six) of radially extending rib portions 6a and separated by 60 degrees from one another, and a plurality (six) of divisional membranes 7 each of which is constructed between adjacent two rib portions 6a, 6a and is formed in an equilateral triangle shape having two rib portions 6a, 6a as two sides. The membrane 3 is, as it is called, an infrared ray detection portion having sensitivity as sensor and is formed as thinner as possible. Although not shown, connection wirings with the membrane 3 are patterned on each column portion 2.

One side of the membrane 3 in the embodiment is formed, for example, in size of about 50 μm. The membrane 3 is preferably formed in a polygonal shape such as a square described later, a rectangle, or the like other than a hexagon etc. in consideration of strength. Further, the support portion may be a frame following an outer contour of the membrane 3 in place of the pair of column portions 2.

As illustrated in FIG. 2, the membrane 3 is formed by laminating an upper electrode layer 11, a pyroelectric layer (dielectric layer) 12 and a lower electrode layer 13 sequentially. The pyroelectric layer 12 is made from, for example, PZT (Pb (Zr, Ti) O₃), SBT (SrBi₂Ta₂O₉), BIT (Bi₄Ti₃O₁₂), LT (LiTaO₃), LN (LiNbO₃), BTO (BaTiO₃), BST (BaSrTiO₃) or the like. In this case, a material having high dielectic constant (such as BST (BaSrTiO₃) or LT (LiTaO₃)) is preferably used for the pyroelectric layer 12 in consideration of detection sensitivity. The pyroelectric layer 12 of the embodiment is formed to have approximately 0.2 μm thickness.

The lower electrode layer 13 is made from, for example, Au, SRO, Nb—STO, LNO (LaNiO₃), etc. In this case, in consideration of film-forming of the pyroelectric layer 12 on the lower electrode layer 13, the lower electrode layer 13 is preferably made from a material having a same crystal structure as that of the pyroelectric layer 12. Further, the lower electrode layer 13 may be made from general Pt, Ir, Ti or the like. On the other hand, the upper electrode layer 11 is made from, for example, Au-Black or the like to enhance absorbability of infrared rays. The upper electrode layer 11 and the lower electrode layer 13 in the embodiment are formed having about 0.1 μm thickness, respectively.

The membrane 3 having such a laminated structure is formed in a convexoconcave shape within a planar surface, technically, in a convexoconcave shape two-dimensionally in a circumferential direction so as to be defined by the reinforcement rib portion 6. More specifically, one of adjacent two divisional membranes 7, 7 is connected to front end portions (upper end portions) of two rib portions 6a, 6a in a width direction and the other is connected to back end portions (lower end portions) of two rib portions 6a, 6a in the width direction. In other words, as to the six divisional membranes 7, three of the six divisional membranes 7 are connected to upper sides of the reinforcement rib portion 6 and the other are connected to lower sides of the reinforcement rib 7 alternately in a circumferential direction, thereby the membrane 3 takes a form of, as it is called, a two-layer structure. Two of the divisional membranes 7 may be connected to an intermediate portion of the reinforcement rib portion 6 with respect to a vertical direction to form a three-layer structure. A multi-layer structure more than three-layer may be formed.

Further, in a case that a sensor array is formed by connecting the infrared ray sensors 1A in a planar surface, as illustrated by imaginary lines in FIG. 1, a connection rib portion 8 is formed to connect to two rib portions 6a, 6a at a connection portion of adjacent two infrared ray sensors 1A. In other words, in the sensor array, each divisional membrane 7 is reinforced by being edged as an equilateral triangle with the two rib portions 6a, 6a and one connection rib portion 8.

While, a height of the reinforcement rib portion 6, that is, length between the adjacent two divisional membranes 7 in a front and back direction is formed longer than thickness of the membrane 3 (the same is true when the membrane 3 has a three-layer structure or the like). For example, in the embodiment, the length in the front and back direction is approximately 2.5 μm.

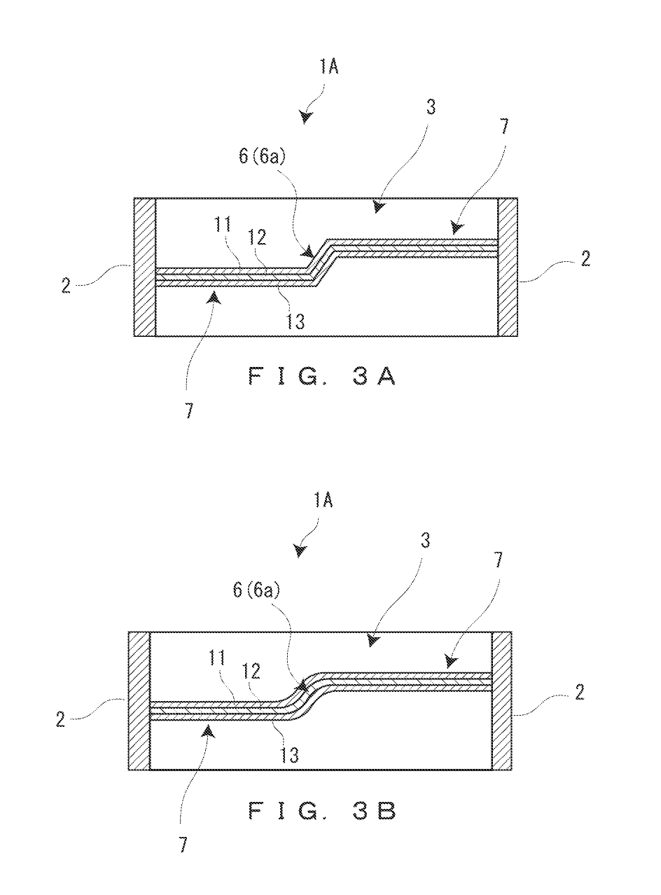

Each rib portion 6a in the embodiment is formed at orthogonal to an in-plane direction of the membrane 3, but it may be inclined. More specifically, as illustrated in FIG. 3A, each rib portion 6a is made to have a cross sectional shape in which the rib portion 6a is inclined (slanted) in some degree to a right angle. In this regard, as illustrated in FIG. 3B, a boundary portion between each rib portion 6a and each divisional membrane 7 is preferably rounded (formed in an R-shape). Having the rounded portions can also be applied to the embodiment of FIG. 2. Thus, rigidity of the membrane 3 in the front and back direction can be enhanced and strength of the infrared ray sensor 1 as a whole with the reinforcement rib portion 6 can be improved.

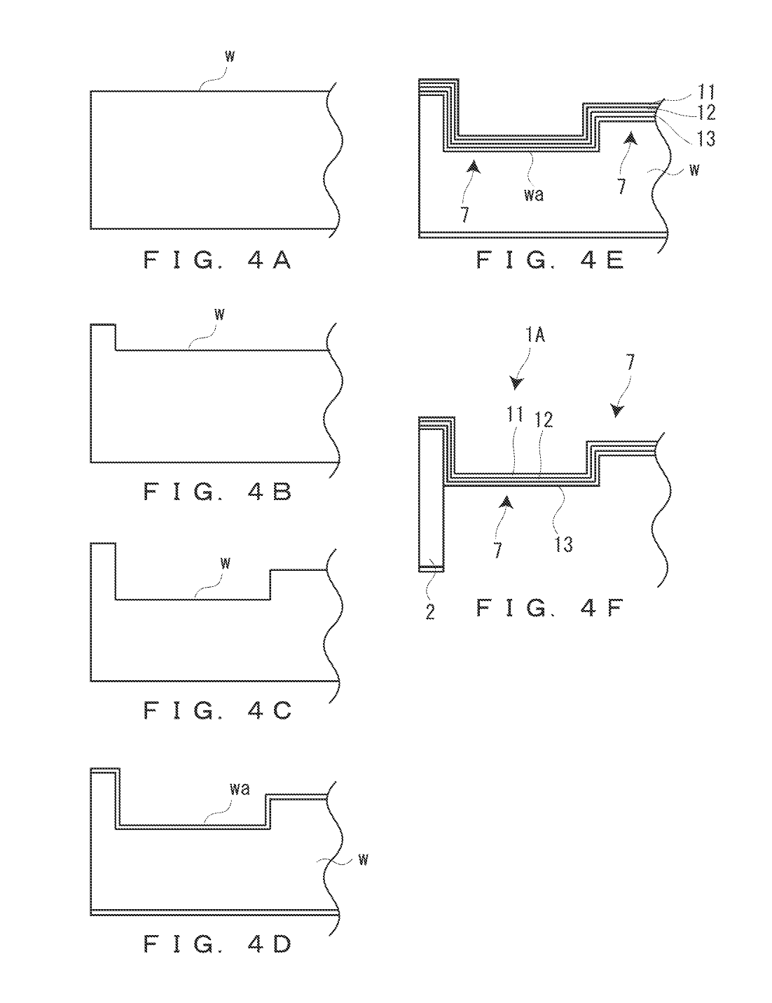

Referring to FIGS. 4A to 4F, a fabrication method of the infrared ray sensor 1A will be explained. The infrared ray sensor 1A in the embodiment is fabricated by microfabrication technology of a semi-conductor with a silicon substrate (wafer) W. The silicon substrate W coated with resist by photo lithography (FIG. 4A) is firstly etched (deep reactive ion etching: anisotropic etching) from an upper (front) side, and a portion to be a top surface of the divisional membrane 7 at the upper side (portion corresponding to a back surface of the lower electrode layer 13 at the upper side divisional membrane 7) is formed (FIG. 4B). Similarly, a second etching (deep reactive ion etching: anisotropic etching) is performed from the upper (front) side and portions of a plurality of (three) divisional membranes 7 (concave portions at the back surface of the lower electrode layer 13) are formed (FIG. 4C). Then, oxidized films (SiO₂) Wa are formed on the front and back surfaces of the silicon substrate W (FIG. 4D) by a thermal oxidation process.

Then, a portion to become the membrane 3 later is film-formed by, for example, epitaxial growth (CVD) with the lower electrode layer 13, the pyroelectric layer 12 and the upper electrode layer 11 sequentially on a front surface of the silicon substrate W, that is, on the oxidized film Wa (FIG. 4E). In the epitaxial growth, buffer layers (not shown) are preferably provided especially between the oxidized film Wa and the lower electrode layer 13 for high quality film-forming, respectively. The buffer layers are preferably formed by YSZ, CeO₂, Al₂O₂ or STO.

Finally, a third etching (for example, isotropic etching by wet etching) is performed from the back surface side or the front side by reversing the sides of the silicon substrate W, and a substrate portion to be a lower side of the membrane 3 is removed (FIG. 4F). In this case, the lower electrode layer 13 of the membrane 3 is made to function as etching stop layer and the column portions 2 are left by managing etching time. In place of the third etching, the substrate portion to be the lower side of the membrane 3 may be formed as a sacrifice layer such as phosphate glass and the sacrifice layer may be removed from the front side. The oxidized film Wa is not necessarily removed completely.

In such a structure, since the membrane 3 is formed by the six radial rib portions 6a and the six divisional membranes 7 constructed between rib portions 6a in a two-layer structure, rigidity (strength) of the membrane 3 overall can be increased. Therefore, the membrane 3 can be formed thinly with a high yield rate. Further, a resonance frequency of the membrane 3 can be extremely raised because of the reinforcement rib portion 6, crash and breakage by vibration can be avoided and microphonics can not be generated. Therefore, a yield ratio and detection sensitivity can be enhanced simultaneously.

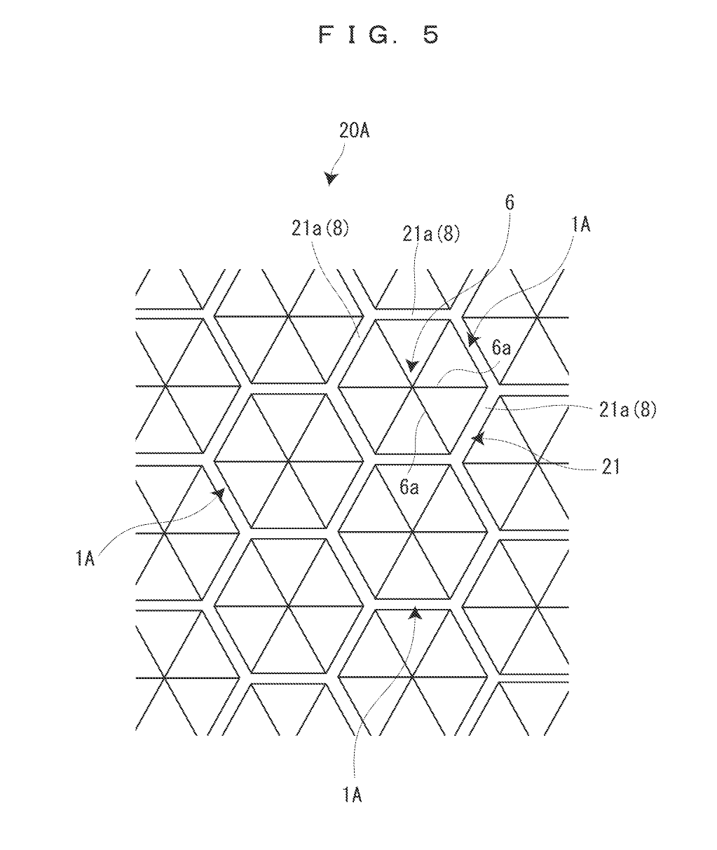

A sensor array (infrared ray detection apparatus) 20A having the infrared ray sensors 1A of the first embodiment as sensor elements will be explained with reference to FIG. 5.

The sensor array 20A is formed in which the support portion of each infrared ray sensor 1A is a hexagonal frame portion 21 provided to surround the membrane. In other words, the sensor array 20A has a structure in which the frame portions 21 are connected in honeycomb geometry and a plurality of infrared ray sensors 1 are supported thereby. Each frame piece 21a of the frame portion 21 serves as the above connection rib portion 8. In other words, the sensor array 20A is constructed by the plurality of infrared ray sensors (sensor elements) 1A disposed on a planar surface in a state that connection rib portions 8 are shared in common.

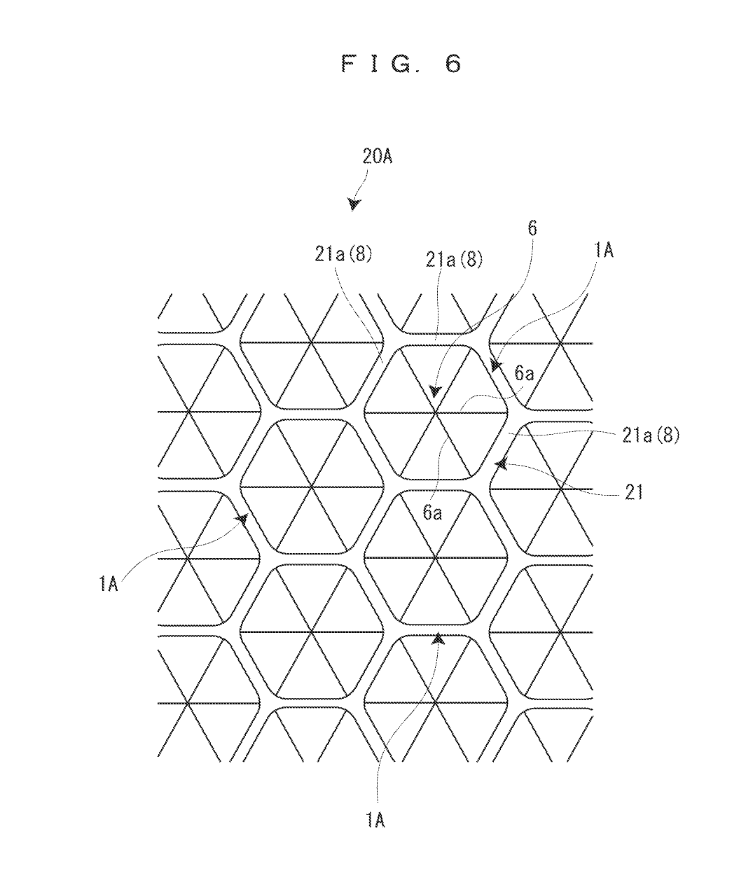

As illustrated in FIG. 6, each corner of the frame portion 21 may be rounded in the above sensor array 20A. Curvature radius of the R-shape is determined in consideration of simplicity of fabrication or strength of the frame portion 21, and the size thereof is arbitrary.

In such an sensor array 20A, since the connection rib portions 8 of the adjacent infrared ray sensors 1A are shared and the connection rib portions 8 serve as a frame portion 21 of each infrared ray sensor 1A, rigidity (strength) of the whole sensor array 20A as a whole can be increased and a ratio of a total area of the membrane 3 to that of the frame portion 21 (connection rib portions 8) can be increased, thereby a yield ratio and detection sensitivity can be improved.

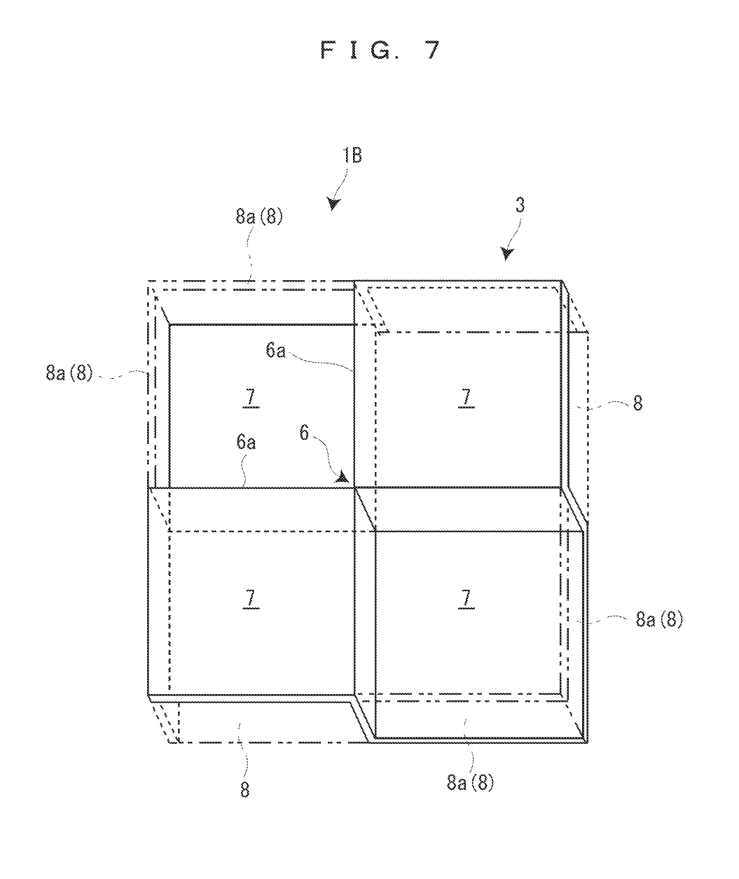

Next, an infrared ray sensor 1B according to the second embodiment of the invention will be explained with reference to FIG. 7. Portions of the infrared ray sensor 1B in the second embodiment different from that of the first embodiment will be mainly explained.

The membrane 3 as a whole of the infrared ray sensor 1B in the embodiment is formed in a square. Further, the membrane 3 has the reinforcement rib portion 6 which is made up of the four rib portions 6a extending radially and separated by 90 degrees from one another, and the four divisional membranes 7 constructed between adjacent two rib portions 6a, 6a and formed in a square with two rib portions 6a, 6a as two sides.

Also in this case, the membrane 3 is formed in a convexoconcave shape in a planar surface so as to be defined by the reinforcement rib portion 6 as the first embodiment. In other words, one of the adjacent two divisional membranes 7, 7 is connected to a front end portion (upper end portion) of two rib portions 6a, 6a in a width direction, and the other is connected to a back end portion of two rib portions 6a, 6a (lower end portion) in the width direction.

Further, in a case that a sensor array is formed by the infrared ray sensors 1B connected in a planar surface, as illustrated by imaginary lines in FIG. 5, an “L”-shaped connection rib portion 8 which is connected to two rib portions 6a, 6a and which is made up of two rib pieces 8a is formed at a connection portion of adjacent two infrared ray sensors 1B. In other words, in the sensor array, each divisional membrane 7 is reinforced to be edged into a square by the two rib portions 6a, 6a and the “L”-shaped connection rib portions 8.

In such a structure, since the membrane 3 is formed by the radial four rib portions 6a and the four divisional membranes 7 in a two layer structure constructed therebetween, rigidity (strength) of the membrane 3 as a whole can be increased and crash/breakage by vibration can be avoided as the first embodiment. Therefore, a yield ratio and detection sensitivity can be improved simultaneously.

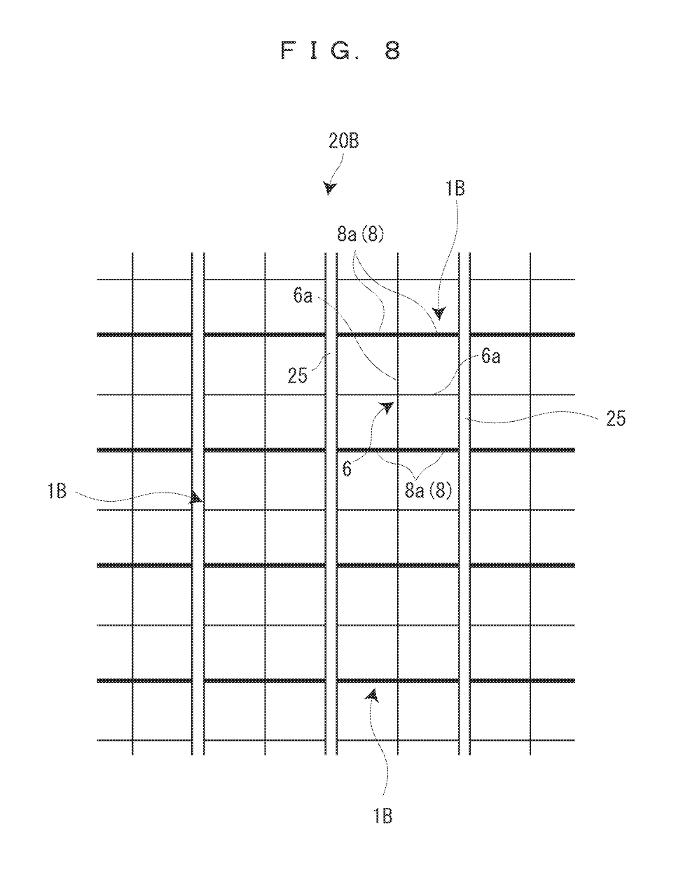

A sensor array (infrared ray detection apparatus) 20B with the infrared ray sensors 1B of the second embodiment as sensor elements will be explained with reference to FIG. 8.

In the sensor array 20B, a support portion of each infrared ray sensor 1B is made up of two stem-shaped portions which support the membrane 3 by two sides. In short, the sensor array 20B has a structure in which the stem-shaped portions 25 are connected in a form of stripe and a plurality of infrared ray sensors 1B are supported thereby. In this case, as to the infrared ray sensors 1B adjacent from side to side, the stem-shape portions 25 serve as connection rib portions 8 (rib pieces 8a) in common, and as to the infrared ray sensors 1B adjacent from front to back, connection rib portions 8 (rib pieces 8a) are shared in common. In other words, the sensor array 20B is formed by the plurality of infrared ray sensors (sensor elements) 1B disposed in a planar surface in a state that connection rib portions 8 are shared in common.

In such a sensor array 20B, since the connection rib portions in adjacent infrared ray sensors 1B are shared and a portion of the connection rib portion serves as the stem-shaped portion 25 of each infrared ray sensor 1B, a ratio of a total area of the membrane 3 to that of the stem-shaped portions 25 (connection rib portions 8) can be increased while rigidity (strength) of the sensor array 20B as a whole can be improved, and a yield ratio and detection sensitivity can be enhanced. The stem-shaped portions may be set up on a substrate and the membrane may be released from the substrate by the stem-shaped portions.

### REFERENCE NUMERALS

1A: infrared ray sensor 1B: infrared ray sensor 2: column portion 3: membrane 6: reinforcement rib portion 6a: rib portion 7: divisional membrane 8: connection membrane 11: upper electrode layer 12: pyroelectric layer 13: lower electrode layer 20A: sensor array 20B: sensor array 21: frame portion 25: stem-shaped portion W: silicon substrate.

1. A MEMS sensor comprising:
a membrane with sensitivity as sensor in a polygon supported by a support portion, the membrane having a reinforcement rib portion made up of a plurality of radially extending rib portions and a plurality of divisional membranes that are constructed between adjacent two rib portions and formed in a polygonal shape with the two rib portions as two sides, and the MEMS sensor constituting each element of a sensor array.

2. The MEMS sensor according to claim 1, wherein the adjacent two divisional membranes are connected to the two rib portions in different flat surfaces respectively.

3. The MEMS sensor according to claim 2, wherein one of the adjacent two divisional membranes is connected to a front end portion of the two rib portions in a width direction and the other is connected to a back end portion of the two rib portions in the width direction.

4. The MEMS sensor according to claim 1, wherein length between the adjacent two divisional membranes in a front and back direction is longer than thickness of the membrane.

5. The MEMS sensor according to claim 1, wherein the polygon to be a shape of the divisional membrane is either a triangle or a quadrangle.

6. The MEMS sensor according to claim 1, wherein the membrane is formed by laminating an upper electrode layer, a pyroelectric layer and a lower electrode layer.

7. A sensor array comprising a plurality of MEMS sensors disposed in a planar surface as set forth in claim 1, a connection rib portion connected to the two rib portions is formed at a connection portion of adjacent two MEMS sensors.

8. A sensor array comprising a plurality of MEMS sensors disposed in a planar surface as set forth in claim 2, a connection rib portion connected to the two rib portions is formed at a connection portion of adjacent two MEMS sensors.

9. A sensor array comprising a plurality of MEMS sensors disposed in a planar surface as set forth in claim 3, a connection rib portion connected to the two rib portions is formed at a connection portion of adjacent two MEMS sensors.

10. A sensor array comprising a plurality of MEMS sensors disposed in a planar surface as set forth in claim 4, a connection rib portion connected to the two rib portions is formed at a connection portion of adjacent two MEMS sensors.

11. A sensor array comprising a plurality of MEMS sensors disposed in a planar surface as set forth in claim 5, a connection rib portion connected to the two rib portions is formed at a connection portion of adjacent two MEMS sensors.

12. A sensor array comprising a plurality of MEMS sensors disposed in a planar surface as set forth in claim 6, a connection rib portion connected to the two rib portions is formed at a connection portion of adjacent two MEMS sensors.
